(19) United States
(12) Patent Application Publication
(10) Pub. No.: US 2006/0141108 A1
(43) Pub. Date: Jun. 29, 2006

(54) Mini tumbler-massager for treating meat

(76) Inventor: Zvi Tene, Hod Hasharon (IL)

Correspondence Address: Gary M. Nath;NATH & ASSOCIATES PLLC, 112 South West Street, Alexandria, VA, 22314, US

(21) Appl. No.: 11/325,628

(22) Filed: Jan. 5, 2006

Related U.S. Application Data
(63) Continuation of application No. PCT/IL04/00598, filed on Jul. 6, 2004.

(30) Foreign Application Priority Data
Jul. 8, 2003 (IL) 156821
Jan. 4, 2004 (IL) 161222

(51) Int. Cl. A23L 1/31

(52) U.S. Cl. 426/281

(57) ABSTRACT

The present invention provides a tumbler and a method for treating meat before cooking. The method includes inserting up to 3 kg of the meat to a tumbler comprising a light-weight chamber securely and rotatably mountable on a support, and is designed to allow the dismantling of the chamber from the tumbler by a typical housekeeper. The method further includes pouring a solution into the tumbler; and operating it to tumble the meat for a desired time period under atmospheric pressure. The tumbler of the invention has ribs that are either with only rounded edges or shaped to have in their cross-section solely obtuse angles, to facilitate massaging of the meat.

### FIELD OF THE INVENTION

This invention relates to a tumbler for treating meat, comprising a chamber, in which meat is rolled in the presence of liquid, solution, brine, and the like in order to be massaged and/or marinated.

### BACKGROUND OF THE INVENTION

It is known in the art of cooking that when meat is cooked, baked, roasted, fried, grilled, etc. it loses between 30 and 40% of its weight, to produce a product that is less juicy than would be desired. This problem is solved in the meat industry by first injecting fluid, such as water, solution and brine, into the meat, and then tumbling the injected meat under vacuum for 1 hour to about 24 hours, such that it adsorbs liquids of a weight that is typically between 40 and 80% of the weight of the precooked meat, (raw meat) and only then cooking.

In domestic kitchens, restaurants, and hotels it is common to marinate meat for several hours or overnight to allow it to absorb fluids in order to obtain a juicy and tasty cooked meat.

WO 03/022073 describes a counter-top appliance having a food container with internal fins extending inward from the outer wall at an angle offset from radial. This publication teaches tumbling food, including meat. In particular, it teaches marinating meat under vacuum conditions.

### SUMMARY OF THE INVENTION

The present invention provides a tumbler for treating meat, which is suitable for use in a kitchen, especially a small scale kitchen. In particular, it provides a tumbler for treating meat in the presence of fluids, comprising a light-weight chamber that is securely and rotatably mountable on a support. The chamber is capable of being loaded with meat and fluid, and has ribs to facilitate massaging of the meat. For this purpose, the ribs are either with only rounded edges or shaped to have in the cross-section solely obtuse angles.

Also provided is a vertical tumbler for treating meat in the presence of fluids designed to allow its domestic use. This tumbler includes a light-weight chamber in the form of a bowl, that is securely mountable on a support with its central axis perpendicular to the support. The bowl is capable of being loaded with meat and fluid, and has a rolling arm that is capable of revolving inside the bowl for tumbling meat loaded therein. The rolling arm has at least one spiral wing having one end near the bottom of the bowl, about 1-2 mm therefrom, and the other end away thereof. The radial extension of the wing is largest at the end that is near the bottom of the bowl, and it decreases towards the other end of the wing. The radial extension of the wing at the bottom of the bowl and its distance from the bottom of the bowl are such that the arm moves freely inside the bowl, but still meat is not caught between the arm and the bowl. Preferably, the angle between the wing and the bottom of the bowl is between 30 and 60°, most preferably about 45°.

The bowl is preferably cylindrical, and this term should be broadly construed, as not to exclude forms of bowls that are conventionally used with food processors, mixers, blenders, and the like.

Both embodiments are particularly useful in a small scale kitchen, which is a kitchen wherein only a small number of similar or identical dishes are prepared at a certain time, such as a domestic kitchen or a kitchen of a high quality restaurant, hotel, and the like. A tumbler of the invention may be useful whenever a small amount of meat, smaller than about 3 kg, is to be treated, and particularly when meat is to be treated immediately before cooking. The chamber's inner volume is thus preferably between 4-7 liter, preferably 5-6 liters.

In the present description and claims the term meat refers to any kind of meat, such as: beef, poultry, pork, lamb, veal, fish, sea-food etc.

The term cooking should be construed to include any kind of process in which heat is applied for preparing food, such as cooking, baking, roasting, frying, grilling, smoking, etc.

The tumbler according to the invention is characterized in its low weight, which allows a typical housekeeper to move it from one place to another without difficulty, to put it into and out of a closet, etc. A tumbler of the invention is typically of a size and weight of a toaster oven, microwave oven, or mixer, of the kinds that are conventionally at domestic use. Thus, the tumbler of the present invention preferably weighs no more than about 5 kg. In particular, the chamber of the tumbler should be light-weight, such that a typical housekeeper may dismantle it from the tumbler in order to clean it, replace it with another chamber, store it, etc., without encountering a difficulty. This requires a low-weight chamber, like that of a mixer bowl conventionally used in domestic kitchens, which is typically less than 1 kg in weight. Furthermore, a chamber of a tumbler according to the invention should be easily placed together with the other parts of the tumbler and dismantled therefrom.

The small weight of the invented tumbler limits the amount of meat to be prepared therein at one batch to be up to about 3 kg of meat. This allows a chef in a restaurant to have meat absorbed with marinade immediately upon receipt of a client's order, and in accordance therewith, in great difference from the standard marinating process, according to which the meat is immersed in the marinade for an overnight. This process allows absorption of only a small portion of the marinade and demands the preparation of marinated meat in advance. The use of a tumbler according to the invention also allows a restaurant to prepare meat dishes that are closer in weight to the weight of the uncooked meat.

For a housekeeper, the tumbler of the invention allows the preparation of a meal without the need of long-term planning, such that without any notice in advance the housekeeper may prepare, for example a steak from marinated meat.

A tumbler according to the invention includes a chamber that is preferably made of a transparent material, at least partially. In such a case, the user is able to see the meat and marinade while being processed in the tumbler, and determine when the tumbling process is finished. Usually, the process is to be stopped when all the fluids are absorbed in the meat, and this is easy to confirm by watching the inside of the tumbler through a transparent material it is made of.

The tumbler of the present invention is preferably free of any vacuum means, that are used in known and industrial tumblers.

Preferably, the chamber of the tumbler of the invention is adapted to revolve around its axis in a frequency of between 1 and 60 rounds per minute (rpm), preferably between 10 and 30 rpm.

According to another aspect of the present invention, there is provided a method for treating meat before its cooling in a small scale kitchen, the method comprising (a) inserting up to 3 kg of the meat to be treated to a tumbler comprising a light-weight chamber securely and rotatably mountable on a support, said tumbler being designed to allow the dismantling of the chamber from the tumbler by a typical housekeeper; (b) pouring a solution into said tumbler; and (c) operating said tumbler to tumble said meat for a desired time period under atmospheric pressure.

The present invention also provides a method for cooking meat, the method comprising:
(a) inserting up to about 3 kg of said meat to a tumbler according to the invention;
(b) pouring into said tumbler a solution;
(c) operating said tumbler for a desired period of time; and
(d) cooking the tumbled meat.

Preferably, said desired period of time is between about 5 to about 10 minutes. The user may select a predetermined time for operating the tumbler, or he (or she) may start the tumbler, and stop it when he determines the tumbling process should be stopped. Preferably, the tumbler is operated until all the solution is absorbed in the meat.

Preferably, the solution to be used according to the invention includes water, salt, spices, and may also include further additives, such as sugar, lemon juice, wine, other alcoholic beverages, oil, honey, starch, curing agents, phosphates, anti-oxidants, flavor enhancers, any commercially available sauce, such as Soya sauce, etc.

Preferably, the amount of solution used according to the invention is between 5% and 30% of the meat pre-cooked, preferably between 10 and 25%, most preferably between 10 and 20%. The exact amount of solution and time of operating the tumbler depends on the specific meat and recipe.

### BRIEF DESCRIPTION OF THE DRAWINGS

In order to understand the invention and to see how it may be carried out in practice, specific embodiments will now be described, by way of non-limiting examples only, with reference to the accompanying drawings, in which:

FIG. 1 is an illustration of a tumbler according to one embodiment of the invention;

FIG. 2 is an illustration of a tumbler according to another embodiment of the invention;

FIG. 3A is a top view illustration of a tumbler according to another embodiment of the invention, having a rolling arm; and

FIG. 3B illustrates a perspective view of the rolling arm of the tumbler shown in FIG. 3A.

FIGS. 4A-4C are schematic cross-sectional views of ribs in a tumbler according to three embodiments of the invention.

FIG. 5 is a schematic cross-sectional view of a chamber of a tumbler according to one embodiment of the invention.

FIGS. 6A-6C are schematic cross-sectional views of ribs that are not symmetrical in respect of their height, attached to the inner wall of the chamber.

### DETAILED DESCRIPTION OF THE INVENTION

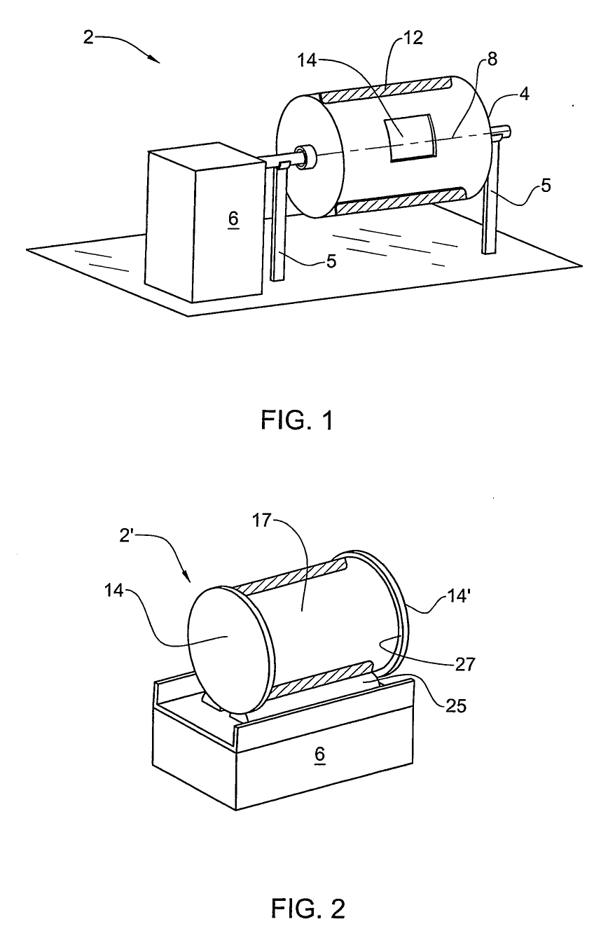

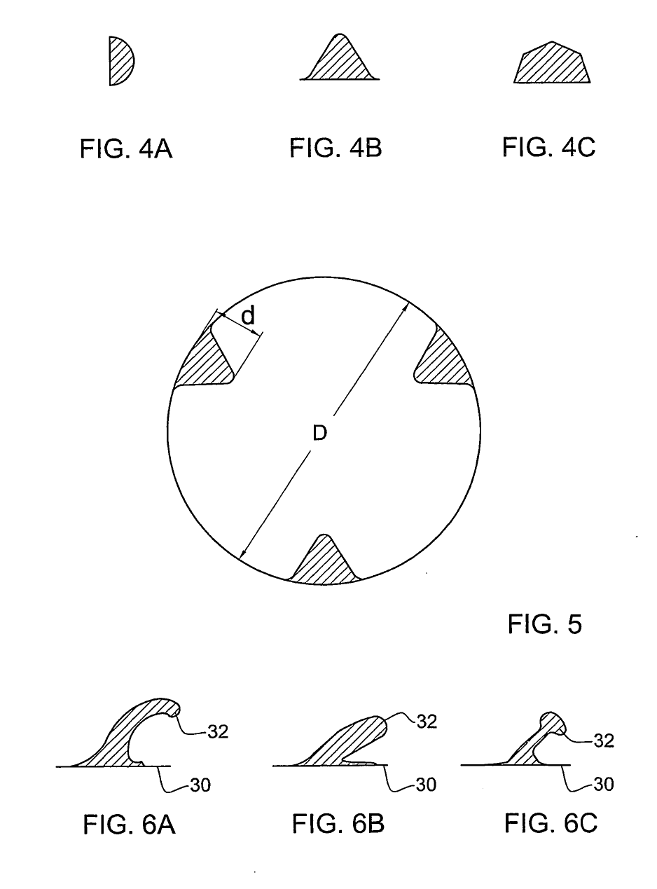

Referring to FIG. 1, it illustrates a horizontal tumbler 2 according to one embodiment of the invention. The tumbler 2 includes a transparent chamber 4 with an axis 8. The chamber 4 is supported on supports 5, and pivotally connected to a motor 6, such that in operation the motor is capable of revolving the chamber around its axis at a predetermined frequency. The chamber 4 has on its inner surface ribs 12 which extend along the axis 8. In the figure, the ribs 12 are parallel to the axis 8, but this is not necessarily so. The ribs are shaped so as to be free of any sharp edges as these might damage the meat tissue rolled in the tumbler. Some possible shapes are shown in FIGS. 4A-4C, and 6A-6C, and described in detail below. The chamber 4 has also a load opening 14, for loading therethrough meat and solution. The opening 14 is equipped with a closure (not shown) sealed to prevent leakage of any solution therefrom.

The chamber 4 is pivotally connected to the motor 6 in a manner that allows easy dismantling for purposes of cleaning, storing, etc. Means for connecting parts in an easily dismantalable manner are well known in the art and there is no need to detail them herein.

In operation, the user loads the chamber 4 with meat and solution (not shown) through opening 14, closes the closure, starts the motor 6, and lets it operate for a predetermined time, or until the user stops its operation, which is usually when the solution is all adsorbed in the meat, which typically takes not longer than 20 minutes, and for many kinds of meats and recipes between 5 and 10 minutes. Therefore, it may be desirable to use a motor designed for short term operation, i.e. for continuous use of no longer than about 30 minutes. The motor may also have an auto-switch that switches off the motor after such a long continuous use. Some other embodiments may be suitable also for tenderizing meat, which requires tumbling the meat after all the liquids are adsorbed therein, for up to about an hour. After the tumbler 2 stops, the user may open the closure to take the meat out through the opening 14 and cook it.

FIGS. 4A-4C illustrate three non-limiting examples of the shape of the ribs suitable for use in the tumbler described above.

All these shapes are designed to allow the rib to interact with a piece of meat in two ways: to drag the piece from the bottom of the chamber without tearing it or penetrating into it, lifting it to a point from which it may fall down back to the bottom, or if it is not dragged, to massage the piece.

The massaging requires that the rib be round-ended or, at least, include only obtuse angles, preferably angles wider than 130°. Most ribs efficiently designed to allow the massaging will be wider near the wall of the chamber than towards its center. The massaging is most efficient if the tumbler has three or four ribs.

It should be noted that it is possible to design a tumbler as described above with at least one rib that is suitable for lifting meat and at least one rib that is suitable for massaging meat. Preferably, each rib is suitable for carrying out both the dragging and massaging functions.

The chamber 4 of the tumbler 2 may also include a plurality of small protrusions (not shown) that do not drag meat pieces but gently massage them.

The rib of FIG. 4A has a shape of half a cylinder. A rib of such shape massages the meat very gently, and does not cause any damage to the tumbled tissue.

FIG. 4B shows a rib of a triangular-like cross-section, with the three comers of the triangle being rounded, not to damage the tissue of the tumbled meat. The triangle is most preferably equilateral, as shown in the figure, but may also be isosceles or of three different side lengths. Preferably, each of the triangle's angles near the side that is attached to the chamber wall is of between 45° and 75°, independently of the other one. Thus, the ribs are not necessarily symmetrical in respect of their height. In case of ribs that are not symmetric or pointing in a direction other than radial, the massaging requires that the chamber revolves in such a direction, that the rib approaches the meat with the side that creates an obtuse angle with the chamber wall.

FIG. 4C shows a rib, in which all angles are obtuse, and the angle that is the closest to the center is of more than 130°.

FIGS. 6A to 6C illustrate other three non-limiting examples of rib shapes suitable for use in the tumbler described above.

Also shown in the figures is a portion 30 of the chamber's inner wall to which the ribs are attached. To achieve massaging the chamber should be rotated clockwise, such that the ribs approach the meat with their part that creates obtuse angle with the chamber's inner wall.

The ribs shown in FIG. 6 have a massaging portion 32 having preferable thickness of about 5-20 mm, preferably 10 mm.

FIG. 5 shows a cross-section in a chamber of a tumbler according to the invention, the chamber having three ribs. It is preferable that the tumbler has three or four ribs. As shown in the figure, it is preferred that the height d of each rib (from the chamber's wall to the outermost point) will be about 15-20%, preferably ⅙ of the chamber's inner diameter D. Thus, if the chamber diameter is about 15-22 cm, the ribs height should be about 2.25-4.5 cm. It should be noted that chambers with inner diameter of less than 15 cm (for instance 13 cm) were tested by the inventor and found to require much longer tumbling times than required with a tumbler having a chamber of larger diameter, such as 20 cm, and the ribs designed in accordance with the above proportions.

FIG. 2 shows another horizontal tumbler 2′ according to the invention, having a similar structure to that of the tumbler 2 of FIG. 1. Reference numeral equal to those used in FIG. 1 are used in FIG. 2 to refer to similar elements in the two tumblers. The main differences between the tumblers is that in the tumbler 2′ the chamber 12 has its opening 14 at its side, and that instead of being supported on supports 5 it is supported on rollers 25, which in operation are rolled by the motor 6 to revolve the chamber 12. To prevent the chamber 12 from sliding aside, its sides 14 and 14′ have restricting edges 27.

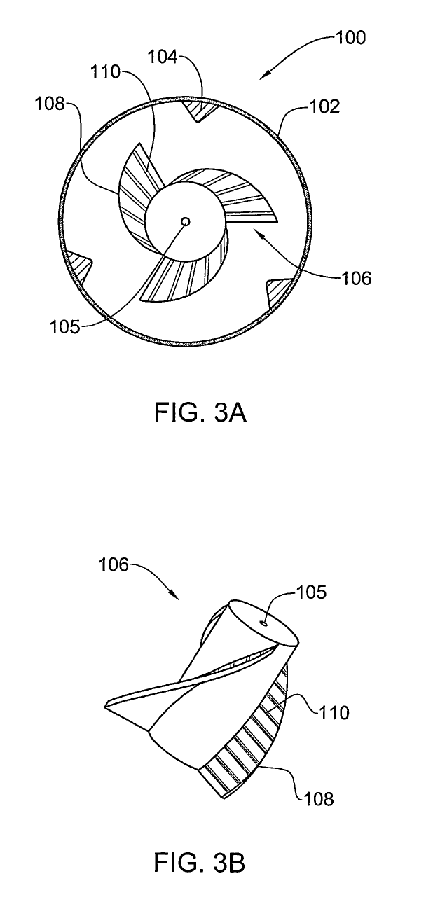

FIG. 3A illustrates a top view of a vertical tumbler according to one embodiment of the invention. The tumbler 100 includes a cylindrical chamber 102 having on it ribs 104 parallel or angled to its axis 105 and going all the way from its top side to its bottom. According to this embodiment of the invention the chamber 102 is static, and has in it a rolling arm 106 having three spiral wings 108, each of said wings extends at the bottom of the chamber to almost the entire radius thereof, and has a radial dimension, which gradually decreases towards the top of the chamber to about one third to one quarter of the chamber's radius. The mixing arm 106 ends about 1-2 mm above the bottom of the chamber.

A similar embodiment, wherein the chamber 102 revolves and the mixing arm 106 is static is also possible.

The wings 108 have protrusions 110 to apply further massage to the meat. Protrusions (not shown) may also appear on the inner wall of the bowl 102 and/or on its bottom. A perspective view of the rolling arm 106 is shown in FIG. 3B.

The chamber 102 is open at its top, and the rolling arm 106 is connected to a motor (not shown). In some embodiments the connection of the arm 106 to the motor is at the arm's top, and in other embodiments—at the arm's bottom. The motor revolves the arm 106 around its axis 105. The arm 106 is made to be easily separated from the motor and taken out of the chamber 102. The chamber 102 is also made to be easily removed from the tumbler 100 for cleaning, storing, etc. The weight of the arm 106 and the bowl 102 is light enough to allow a typical housekeeper handling each of them for removing, cleaning, storing, and the like, with no difficulty. The material, from which the bowl 102 is made, may be transparent, but this is not of a large advantage over opaque materials, since the meat in the bowl may be observed from the open top of the bowl.

In operation, the user loads the chamber 102 with meat and solution (not shown) through its topside, starts the motor and lets it operate for a predetermined time or until the user stops its operation. According to one embodiment of the invention the motor works in two directions to revolve the arm clockwise and anti-clockwise, such that in operation the meat climbs on the wings 108 when the motor works in one direction, and climbs down when the motor works in the other direction.

According to another embodiment of the invention the motor revolves the mixing arm constantly in a single direction, when the meat climbs up the mixing wings, and falls down when it reaches their top.

Although the invention was described in details only in respect of the above embodiments, it is not restricted thereto, and its full scope should be determined by the following claims.

1-29. (canceled)

30. A tumbler for treating meat in the presence of fluids, comprising a light-weight chamber securely and rotatably mountable on a support, said chamber being capable of being loaded with meat and fluid, being designed to allow its domestic use, and having ribs that are either with only rounded edges or shaped to have in their cross-section solely obtuse angles, to facilitate massaging of the meat.

31. A tumbler according to claim 30, wherein said chamber is free of any vacuum means.

32. A tumbler according to claim 30, having three or four ribs.

33. A tumbler according to claim 30, having ribs with a height that is between 15% and 20% of the chamber's inner diameter.

34. A tumbler according to claim 30, designed to allow the dismantling of the chamber from the tumbler by a typical housekeeper.

35. A tumbler according to claim 30, which is light-weight such that it may be easily handled by a typical housekeeper.

36. A tumbler according to claim 35, wherein said chamber has a weight of less than 2 kg.

37. A tumbler according to claim 35, having a total weight of about 5 kg or less.

38. A tumbler according to claim 30, having a revolving mechanism, capable of rolling meat loaded in said chamber, wherein said revolving mechanism is designed for short term operations.

39. A tumbler according to claim 30, wherein at least part of said chamber is transparent.

40. A tumbler according to claim 30, wherein said chamber is made of a transparent material.

41. A tumbler for treating meat in the presence of fluids, comprising a light-weight bowl having a central axis and being securely mountable on a support with said central axis perpendicular to said support, said bowl being capable of being loaded with meat and fluid, designed to allow its domestic use, and having a mixing arm with at least one spiral wing, said arm being capable of revolving inside said bowl for tumbling meat loaded therein; each of said at least one wing has a first end and a second end, said first end being located near the bottom of said bowl, the radial extension of said wing at its first end being about 90% of the diameter of the bowl, and decreases towards its second end.

42. A tumbler according to claim 41 wherein said bowl has a cylindrical shape.

43. A tumbler according to claim 41 further having ribs extending at the inner surface of said bowl along said central axis.

44. A tumbler according to claim 43, wherein said ribs being either with only round edges or shaped to have in the cross-section solely obtuse angles.

45. A tumbler according to claim 41 wherein said arm has three spiral wings.

46. A tumbler according to claim 41 wherein the radial dimension of the wings at their second end is one third of the radius of the bowl.

47. A tumbler according to claim 41, wherein said wings have protrusions to apply further massage to the meat.

48. A tumbler for treating meat in the presence of fluids, comprising a light-weight chamber securely and rotatably mountable on a support, said chamber being capable of being loaded with meat and fluid, being designed to allow its domestic use, and being free of vacuum means.
